(19) United States
(12) Patent Application Publication
(10) Pub. No.: US 2018/0305218 A1
(43) Pub. Date: Oct. 25, 2018

(54) INFRARED RADIATION BLOCKING MATERIAL AND COATING USING THE SAME

(71) Applicant: National Tsing Hua University, Hsinchu City (TW)

(72) Inventors: Chi-Young Lee, Hsinchu City (TW); Hsin-Tien Chiu, Hsinchu City (TW); Min-Chiao Tsai, Tainan City (TW); Chao-Wu Chu, Hsinchu City (TW)

(73) Assignee: National Tsing Hua University, Hsinchu City (TW)

(21) Appl. No.: 15/912,578

(22) Filed: Mar. 6, 2018

(30) Foreign Application Priority Data
Apr. 21, 2017 (TW) 106113343

(51) Int. Cl. C01G 23/047; C01G 9/02; C01B 33/12; C09D 5/33; C03C 17/23; D06M 11/44; D06M 11/46

(52) U.S. Cl. CPC C01G 23/047; C01G 9/02; C01B 33/12; C09D 5/004; C03C 17/23; D06M 11/44; D06M 2200/25; C01P 2004/32; C01P 2004/51; C01P 2004/61; C01P 2006/90; C03C 2217/70; D06M 11/46

(57) ABSTRACT

Provided is an infrared radiation blocking material including a plurality of microspheres. The particle size of each of the microspheres is 1000 nm to 2600 nm. The microspheres have a light transmittance of at least 50% within the light wavelength range of 400 nm to 700 nm and have a blocking rate of greater than 40% within the light wavelength range of 700 nm to 1500 nm.

### CROSS-REFERENCE TO RELATED APPLICATION

This application claims the priority benefit of Taiwan application serial no. 106113343, filed on Apr. 21, 2017. The entirety of the above-mentioned patent application is hereby incorporated by reference herein and made a part of this specification.

### BACKGROUND OF THE INVENTION

### Field of the Invention

The invention relates to a material and a coating using the same, and more particularly, to an infrared radiation blocking material and a coating using the same.

### Description of Related Art

With the rapid development of the global economy, issues such as energy depletion and the continuously rising of ambient temperature prompt nations around the world to actively promote and develop energy-saving industries. Therefore, thermal insulation and energy saving products are gaining more and more attention, wherein the most extensively applied thermal insulation and energy saving product is a coating having thermal insulation efficacy.

In general, the energy of the sunlight irradiated on Earth can be divided into three portions, which are respectively about 2% UV, about 47% visible light, and about 51% infrared. Infrared is invisible light, and in a sunny environment, ordinary objects all absorb infrared such that thermal energy is accumulated and the objects are heated and become hot. However, an object having infrared reflection or scattering properties does not accumulate thermal energy. Therefore, how to develop a material or coating having infrared radiation blocking properties to achieve the effect of thermal insulation and energy saving is an important topic.

### SUMMARY OF THE INVENTION

The invention provides an infrared radiation blocking material and a coating using the same that can achieve the effect of thermal insulation and energy saving.

The invention provides an infrared radiation blocking material including a plurality of microspheres. The particle size of each of the microspheres is 1000 run to 2600 nm. The microspheres have a light transmittance of at least 50% within the light wavelength range of 400 nm to 700 nm and have a blocking rate of greater than 40% within the light wavelength range of 700 nm to 1500 nm.

In an embodiment of the invention, the material of the microspheres includes titanium dioxide, zinc oxide, silicon oxide, or a combination thereof.

In an embodiment of the invention, the microspheres are solid microspheres.

In an embodiment of the invention, the ratio of the long radius and the short radius of each of the microspheres is between 1.00 and 1.10.

In an embodiment of the invention, the difference of any two diameters of the microspheres is less than or equal to 143 nm.

In an embodiment of the invention, the difference of any two diameters of the microspheres is between 6 nm and 143 nm.

In an embodiment of the invention, the standard deviation of the particle size distribution of the microspheres is less than 43 nm.

The invention provides a coating including the infrared radiation blocking material, wherein the coating covers the surface of a substrate or is mixed in the substrate.

In an embodiment of the invention, the substrate includes glass, wall, fabric, or a combination thereof.

Based on the above, the infrared radiation blocking material of the invention has solid microspheres having a particle size of 1000 nm to 2600 nm. The solid microspheres have a light transmittance of at least 50% within the light wavelength range of 400 nm to 700 nm and have a blocking rate of greater than 40% within the light wavelength range of 700 nm to 1500 nm. Therefore, the infrared radiation blocking material and the coating containing the same of the invention can effectively block infrared and achieve the effect of thermal insulation and energy saving.

In order to make the aforementioned features and advantages of the disclosure more comprehensible, embodiments accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 to FIG. 6 are electron micrographs of titanium dioxide microspheres having different particle sizes.

FIG. 7 is a diagram showing a relationship between transmittance and wavelength of comparative examples 1 to 4 and experimental examples 1 to 4.

FIG. 8 is a diagram showing a relationship between temperature and time of comparative examples 5 to 8 and experimental examples 5 to 7.

FIG. 9A to FIG. 9B are electron micrographs of the non-spherical titanium dioxide of comparative example 1.

### DESCRIPTION OF THE EMBODIMENTS

In the present specification, ranges represented by “a numerical value to another numerical value” is a schematic representation of avoiding listing all of the numerical values in the range in the specification. Therefore, the recitation of a specific numerical range discloses any numerical value in the numerical range and a smaller numerical range defined by any numerical value in the numerical range, as is the case with any numerical value and a smaller numerical range stated expressly in the specification. For instance, the range of “a particle size of 1000 nm to 2600 nm” discloses the range of “a size of 1500 nm to 2000 nm”, regardless of whether other numerical values are listed in the specification.

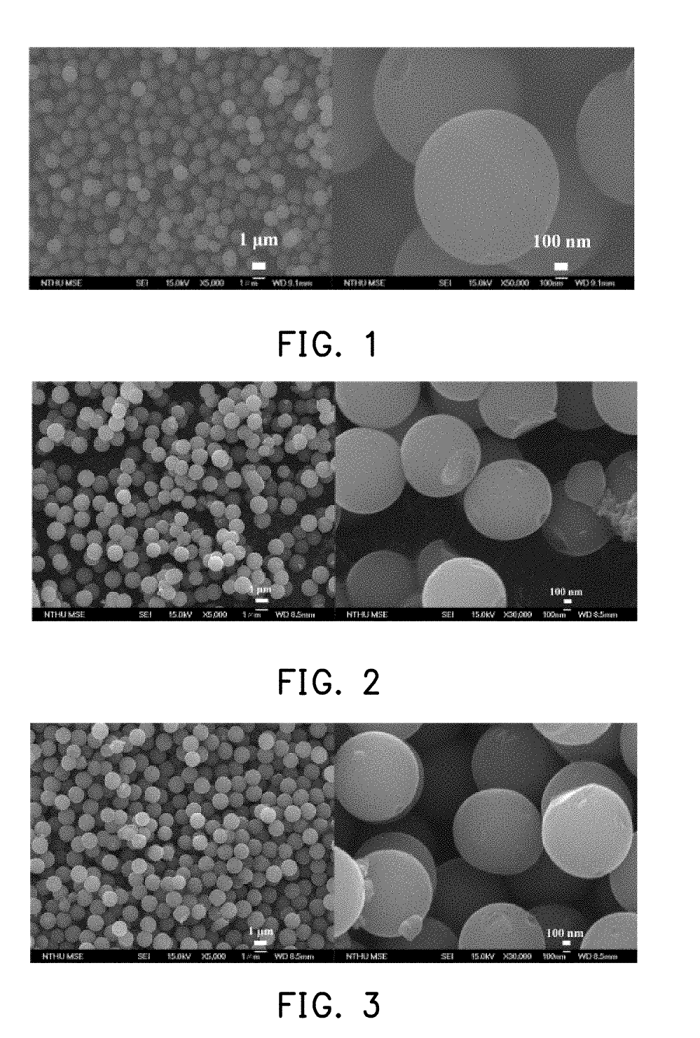

FIG. 1 to FIG. 6 are electron micrographs of titanium dioxide microspheres having different particle sizes.

The invention provides an infrared radiation blocking material including a plurality of microspheres. In an embodiment, the microspheres can be solid microspheres. In an embodiment, the particle size of each of the microspheres is 1000 nm to 2600 nm. In another embodiment, the particle size of each of the microspheres is 1000 nm to 1300 nm. In an embodiment, the material of the microspheres can be, for instance, titanium dioxide, zinc oxide, silicon oxide, or a combination thereof.

Referring to FIG. 1 to FIG. 6, titanium dioxide microspheres having different particle sizes are all prepared using a sol-gel method. Specifically, a first mixed solution is provided. The first mixed solution is formed by pre-mixing 150 ml to 200 ml of alcohol (concentration: 99.5%), 0.5 ml to 1.0 ml of caprylic acid (concentration: 99%), 1.0 ml to 1.2 ml of tetraisopropyl titanium (concentration: 97%), and 0.25 ml to 1.25 ml of deionized water in order for 15 minutes and evenly mixing the components at a rotating speed of 100 rpm to 200 rpm using a magnet. Next, a second mixed solution (formed by evenly mixing 2.0 ml to 10.0 ml of alcohol (concentration: 99.5%) and 2.0 ml to 10.0 ml of deionized water) is added in the first mixed solution to form a third mixed solution. During the addition, the rotating speed of the magnet is increased to 600 rpm to 900 rpm, and after stirring for 1 second to 5 seconds, the rotating speed is slowly returned to 100 rpm to 200 rpm. Next, the third mixed solution is left to stand at room temperature (about 22° C. to 28° C.) for 1 hour to 4 hours. Next, vacuum filtration is performed on the third mixed solution to filter out a gel. After the gel is dried and milled, white powder having titanium dioxide microspheres is obtained. In an embodiment, titanium dioxide solid spheres having different particle sizes are synthesized by adjusting the content of deionized water in the second mixed solution. For instance, a greater deionized water content results in a smaller particle size of the synthesized titanium dioxide solid spheres.

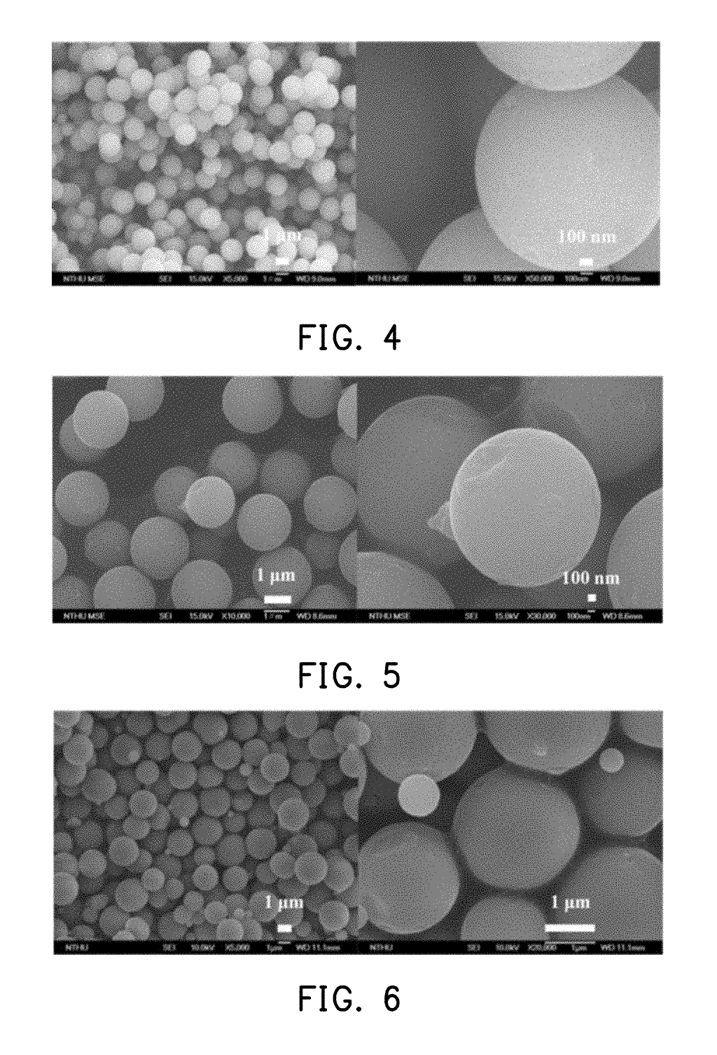

As shown in FIG. 1, the particle size of the titanium dioxide microspheres is 1000 nm. As shown in FIG. 2, the particle size of the titanium dioxide microspheres is 1200 nm. As shown in FIG. 3, the particle size of the titanium dioxide microspheres is 1300 nm. As shown in FIG. 4, the particle size of the titanium dioxide microspheres is 1700 nm. As shown in FIG. 5, the particle size of the titanium dioxide microspheres is 2300 nm. As shown in FIG. 6, the particle size of the titanium dioxide microspheres is 2600 nm.

It can be known from FIG. 1 to FIG. 6 that, the titanium dioxide microsphere shape of the present embodiment is a circle such as a perfect circle or quasi-circle, and the size is even. The circle or quasi-circle here implies that the ratio of the long radius and the short radius of each titanium dioxide microsphere is substantially close to 1. In an embodiment, the ratio of the long radius and the short radius of each titanium dioxide microsphere is 1.00 to 1.10. In another embodiment, the ratio of the long radius and the short radius of each titanium dioxide microsphere is 1.00 to 1.05. In an alternate embodiment, the difference of any two diameters of the titanium dioxide microspheres is less than or equal to 143 nm. In another embodiment, the difference of any two diameters of the titanium dioxide microspheres is between 6 nm and 143 nm. In an alternate embodiment, the standard deviation of the particle size distribution of the titanium dioxide microspheres is less than 43 nm.

It should be mentioned that, the microspheres have a light transmittance of at least 50% within the light wavelength range of 400 nm to 700 nm and have a blocking rate of greater than 40% within the light wavelength range of 700 nm to 1500 nm. In other words, the microspheres have visible light transmittance, and have an infrared radiation block rate at the same time. Therefore, the microspheres or a material including the microspheres has the effect of thermal insulation and energy saving.

In an embodiment, the microspheres or a material including the microspheres can be added in a coating such that the coating also has the effect of thermal insulation and energy saving. Therefore, the coating covers the surface of a substrate or is mixed in the substrate such that the substrate has infrared radiation blocking properties to reduce the temperature of the substrate surface and achieve the effect of thermal insulation. For instance, the microspheres can be added in a paint, and then the paint is coated on the external wall of a building. Even if the external wall of the building is subjected to prolonged exposure, most of the infrared radiation is scattered by the paint including the microspheres such that thermal energy is not readily accumulated. As a result, the temperature of the entire building is reduced such that people in the building do not readily feel hot and the usage of air conditioning is reduced, and therefore the effect of energy and carbon saving is achieved. Moreover, in a cold environment, the paint can also be coated on the interior wall of a building such that the internal heat of the building is not readily dissipated so as to achieve a heat retaining effect. In other embodiments, the material including the microspheres can also be coated on a window glass such that the building has good lighting and the usage of air conditioning is reduced to achieve the effect of energy saving. However, the invention is not limited thereto, and in other embodiments, the substrate can be, for instance, fabric or other objects requiring thermal insulation.

A plurality of experimental examples is provided below to further describe the infrared radiation blocking material and the coating using the same of the invention. In the following, the transmittance for a wavelength of 400 nm to 2000 nm is tested by UV-Vis/NIR V670 (made by JASCO International).

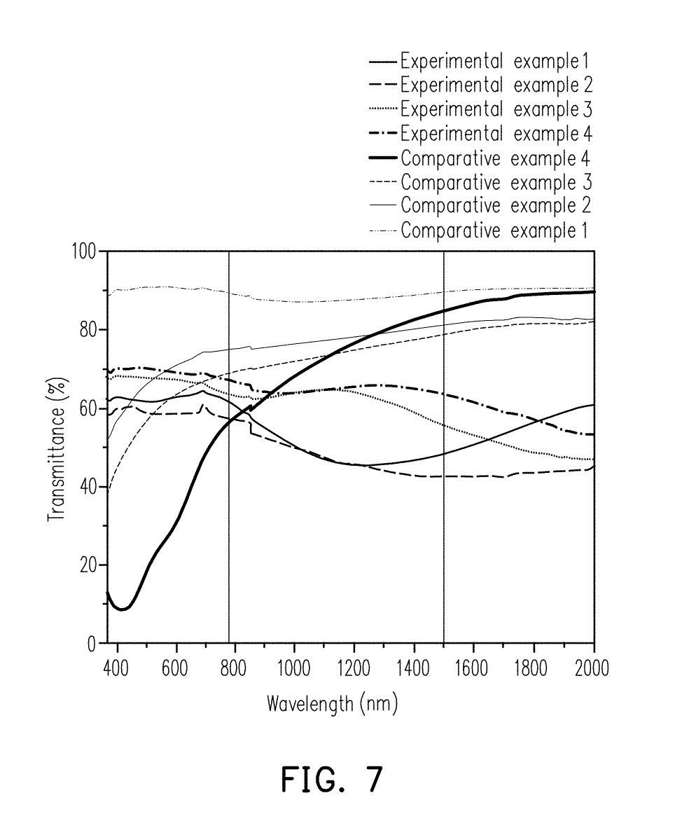

FIG. 7 is the diagram showing the relationship between transmittance and wavelength of comparative examples 1 to 4 and experimental examples 1 to 4.

### Comparative Example 1

In comparative example 1, the transmittance of a glass substrate having a size of 25 mm×17 mm and a thickness of 1.0 mm was tested using UV-Vis/NIR V670 at a wavelength of 400 nm to 2000 nm, and the results thereof are as shown in FIG. 7.

### Comparative Example 2

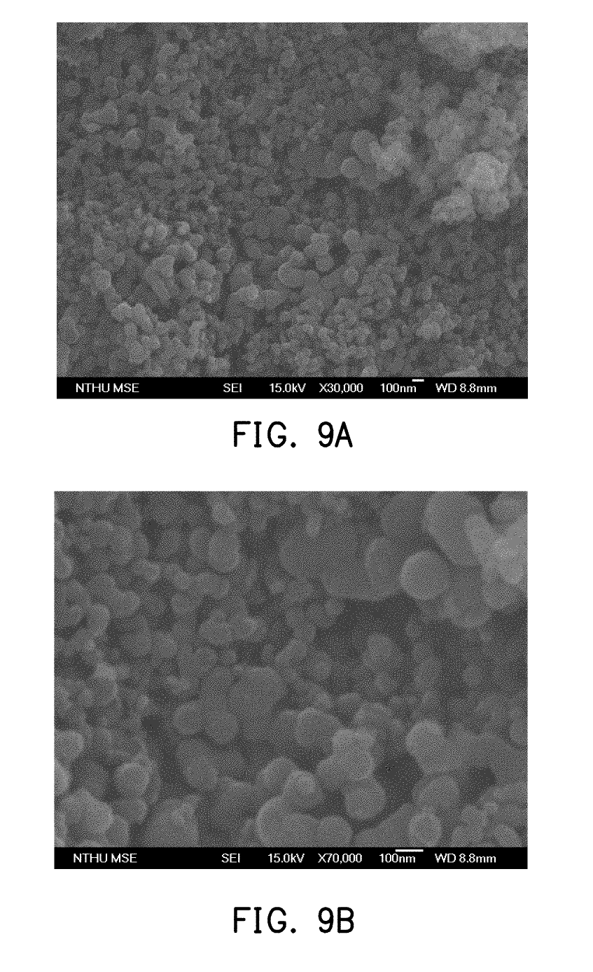

In comparative example 2, 200 ml of alcohol, 3 ml of tetraisopropyl titanium, and 50 ml of deionized water were mixed and reacted for 1 hour to form the titanium dioxide of comparative example 2. It can be known from FIGS. 9A to 9B that, the shape of the titanium dioxide of comparative example 2 is non-spherical without a specific form. Moreover, the particle size distribution of the titanium dioxide of comparative example 2 is also relatively uneven. The non-spherical pure titanium dioxide and alcohol were made into a 1 wt % solution, and a sample was coated on a glass substrate having a size of 25 mm×17 mm and a thickness of 1.0 mm using spin coating for transmittance testing at a wavelength of 400 nm to 2000 nm, and the results thereof are as shown in FIG. 7.

### Comparative Example 3

In comparative example 3, commercial titanium dioxide (made by Evonik Industries, model: P25) and alcohol were made into a 1 wt % solution, and a sample was coated on a glass substrate having a size of 25 mm×17 mm and a thickness of 1.0 mm using spin coating for transmittance testing at a wavelength of 400 nm to 2000 nm, and the results thereof are as shown in FIG. 7.

### Comparative Example 4

In comparative example 4, titanium dioxide microspheres having a particle size of 300 nm were prepared using a sol-gel method. Thereafter, the titanium dioxide microspheres and alcohol were respectively made into a 1 wt % solution, and a sample was coated on a glass substrate having a size of 25 mm×17 mm and a thickness of 1.0 mm using spin coating for transmittance testing at a wavelength of 400 nm to 2000 nm, and the results thereof are as shown in FIG. 7.

### Experimental Examples 1 to 4

In experimental examples 1 to 4, titanium dioxide microspheres having a particle size of 1000 nm, 1300 nm, 1700 nm, and 2300 nm were respectively prepared using a sol-gel method. Thereafter, the titanium dioxide microspheres and alcohol were respectively made into a 1 wt % solution, and a sample was coated on a glass substrate having a size of 25 mm×17 mm and a thickness of 1.0 mm using spin coating for transmittance testing at a wavelength of 400 urn to 2000 nm, and the results thereof are as shown in FIG. 7.

It can be known from the results of FIG. 7 that, the transmittance of the titanium dioxide microspheres of experimental examples 1 to 4 at the infrared wavelength range (700 nm to 1500 nm) is significantly less than those of the glass substrate (i.e., without titanium dioxide microspheres) of comparative example 1 and the titanium dioxides of comparative examples 2 to 4. In other words, the titanium dioxide microspheres of experimental examples 1 to 4 can effectively block infrared radiation to achieve the effect of thermal insulation. Moreover, in experimental examples 1 to 4, the titanium dioxide microspheres having a particle size of 1300 nm of experimental example 2 have the best visible light transmittance and the best infrared radiation block rate. Specifically, within the visible light wavelength range (400 nm to 700 nm), the visible light transmittance of the titanium dioxide microspheres of experimental example 2 can be greater than 50% and the infrared radiation block rate thereof can be greater than 40%. In other words, the titanium dioxide microspheres of experimental example 2 can be applied on a window glass such that the building has good lighting and the usage of air conditioning is reduced to achieve the effect of energy saving.

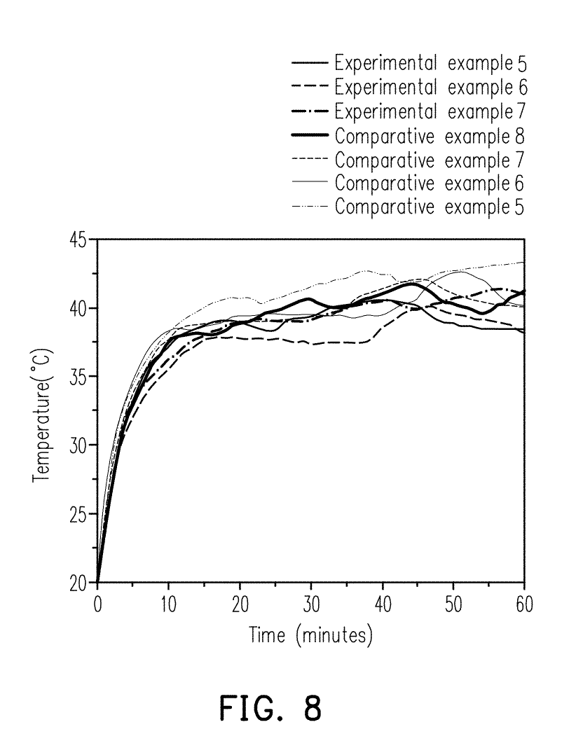

FIG. 8 is the diagram showing the relationship between temperature and time of comparative examples 5 to 8 and experimental examples 5 to 7.

### Comparative Example 5

In comparative example 5, a glass substrate having a size of 25 mm×17 mm and a thickness of 1.0 mm was heated using a tungsten filament lamp and temperature testing was performed using a type K thermocouple, and the results thereof are as shown in FIG. 8.

### Comparative Example 6

In comparative example 6, non-spherical pure titanium dioxide (the manufacturing steps thereof are as provided in comparative example 2) and alcohol were made into a 1 wt % solution, and a sample was coated on a glass substrate having a size of 25 mm×17 mm and a thickness of 1.0 mm using spin coating. Next, the glass substrate was heated using a tungsten filament lamp, and temperature testing was performed using a type K thermocouple, and the results thereof are as shown in FIG. 8.

### Comparative Example 7

In comparative example 7, commercial titanium dioxide (made by Evonik Industries, model: P25) and alcohol were made into a 1 wt % solution, and a sample was coated on a glass substrate having a size of 25 mm×17 mm and a thickness of 1.0 mm using spin coating. Next, the glass substrate was heated using a tungsten filament lamp, and temperature testing was performed using a type K thermocouple, and the results thereof are as shown in FIG. 8.

### Comparative Example 8

In comparative example 8, titanium dioxide microspheres having a particle size of 300 nm were prepared using a sol-gel method. Next, the titanium dioxide microspheres and alcohol were made into a 1 wt % solution, and a sample was coated on a glass substrate having a size of 25 mm×17 mm and a thickness of 1.0 mm using spin coating. Next, the glass substrate was heated using a tungsten filament lamp, and temperature testing was performed using a type K thermocouple, and the results thereof are as shown in FIG. 8.

### Experimental Examples 5 to 7

In experimental examples 5 to 7, titanium dioxide microspheres having a particle size of 1000 nm, 1300 nm, and 1700 nm were respectively prepared using a sol-gel method. Thereafter, the titanium dioxide microspheres and alcohol were respectively made into a 1 wt % solution, a sample was coated on a glass substrate having a size of 25 mm×17 mm and a thickness of 1.0 mm using spin coating, temperature testing was performed, and the results thereof are as shown in FIG. 8.

It can be known from the results of FIG. 8 that, the titanium dioxide microspheres having a particle size of 1300 nm of experimental example 6 can block temperature increase to achieve the effect of long-term thermal insulation. In other words, when the titanium dioxide microspheres of experimental example 6 are applied on a window glass or coating, the temperature inside the building can be maintained for a long time and the usage of air conditioning can be reduced to achieve the effect of energy saving.

Based on the above, the infrared radiation blocking material of the invention has solid microspheres having a particle size of 1000 nm to 2600 nm. The solid microspheres have a light transmittance of at least 50% within the light wavelength range of 400 nm to 700 nm and have a blocking rate of greater than 40% within the light wavelength range of 700 nm to 1500 nm. Therefore, the infrared radiation blocking material and the coating containing the same of the invention can effectively block infrared and achieve the effect of thermal insulation and energy saving.

Although the invention has been described with reference to the above embodiments, it will be apparent to one of ordinary skill in the art that modifications to the described embodiments may be made without departing from the spirit of the invention. Accordingly, the scope of the invention is defined by the attached claims not by the above detailed descriptions.

What is claimed is:

1. An infrared radiation blocking material, comprising:
a plurality of microspheres, wherein a particle size of each of the microspheres is 1000 nm to 2600 nm, the microspheres have a light transmittance of at least 50% within a light wavelength range of 400 nm to 700 nm and have a blocking rate of greater than 40% within a light wavelength range of 700 nm to 1500 nm.

2. The infrared radiation blocking material of claim 1, wherein a material of the microspheres comprises titanium dioxide, zinc oxide, silicon oxide, or a combination thereof.

3. The infrared radiation blocking material of claim 1, wherein the microspheres are solid microspheres.

4. The infrared radiation blocking material of claim 1, wherein a ratio of a long radius and a short radius of each of the microspheres is between 1.00 and 1.10.

5. The infrared radiation blocking material of claim 1, wherein a difference of any two diameters of the microspheres is less than or equal to 143 nm.

6. The infrared radiation blocking material of claim 1, wherein a difference of any two diameters of the microspheres is between 6 nm and 143 nm.

7. The infrared radiation blocking material of claim 1, wherein a standard deviation of a particle size distribution of the microspheres is less than 43 nm.

8. A coating comprising the infrared radiation blocking material of claim 1, wherein the coating covers a surface of a substrate or is mixed in the substrate.

9. The coating of claim 8, wherein the substrate comprises glass, wall, fabric, or a combination thereof.
